(19) United States
(12) Patent Application Publication
(10) Pub. No.: US 2007/0054190 A1
(43) Pub. Date: Mar. 8, 2007

(54) Lithium secondary battery

(76) Inventors: Atsushi Fukui, Kobe-shi (JP); Hiroshi Minami, Kobe-shi (JP); Yasuyuki Kusumoto, Kobe-shi (JP)

Correspondence Address: KUBOVCIK & KUBOVCIK, SUITE 710, 900 17TH STREET NW, WASHINGTON, DC, 20006, US

(21) Appl. No.: 11/516,523

(22) Filed: Sep. 7, 2006

(30) Foreign Application Priority Data
Sep. 7, 2005 (JP) 2005-259089

(51) Int. Cl. H01M 4/58; H01M 4/62

(52) U.S. Cl. 429/218.1; 429/232; 429/217

(57) ABSTRACT

A lithium secondary battery has a positive electrode, a negative electrode, and a non-aqueous electrolyte. The negative electrode has a negative electrode current collector and a negative electrode mixture layer containing a negative electrode conductive agent, a negative electrode binder, and negative electrode active material particles made of a material containing silicon. The negative electrode mixture layer is sintered and disposed on the negative electrode current collector. The negative electrode active material particles have an average particle size of from 5.0-15.0 μm before being charged. The negative electrode conductive agent is made of a graphite material having an average particle size of from 2.5-15.0 μm. The amount of the graphite material added is from 3-20 mass % with respect to the negative electrode active material. The theoretical electrical capacity ratio of the positive electrode to the negative electrode is 1.0 or less.

### BACKGROUND OF THE INVENTION

1. Field of the Invention

The present invention relates to lithium secondary batteries using a material containing silicon as a negative electrode active material.

2. Description of Related Art

Rapid advancements in size and weight reductions of mobile information terminal devices such as mobile telephones, notebook computers, and PDAs in recent years have created demands for higher capacity batteries as driving power sources for the devices. With their high energy density and high capacity, lithium secondary batteries that charge and discharge by transferring lithium ions between the positive and negative electrodes have been widely used as the driving power sources for the mobile information terminal devices. It has been expected that, due to further size reduction and advanced functions of these portable devices, requirements for the lithium secondary batteries as the device power sources will continue to escalate in the future. Thus, demands for higher energy density in the lithium secondary batteries have been increasingly high.

An effective means to achieve higher energy density in a battery is to use a material having a greater energy density as its active material. Recently, aluminum, tin, and silicon, which intercalate lithium through an alloying reaction with lithium, have been studied and considered as candidates for the negative electrode active materials for lithium secondary batteries that are capable of higher energy density and will replace carbon materials, such as graphite, which are currently in commercial use.

However, the use of a material that alloys with lithium as a negative electrode active material of a lithium secondary battery has the following problem. The negative electrode active material expands and shrinks during charging and discharging, abruptly changing its volume. Consequently, as the charge-discharge process is repeated, the negative electrode active material pulverizes or peels off from the negative electrode current collector. This degrades the current collection performance within the electrode, leading to poor charge-discharge cycle performance.

In view of the problem, Japanese Published Unexamined Patent Application No. 2002-260637, which is assigned to the assignee of the present invention, proposes the use of a negative electrode formed by sintering a negative electrode mixture layer containing an active material composed of a material containing silicon, a conductive carbon material, and a negative electrode binder under a non-oxidizing atmosphere. This electrode exhibits high adhesion between the negative electrode mixture layer and the negative electrode current collector and thus achieves high current collection performance and good charge-discharge cycle performance.

Nevertheless, even with the lithium secondary battery prepared by the just-described technique, the improvement in the initial charge-discharge efficiency has not been sufficient, and moreover, further improvements in the cycle performance are expected. Thus, there exists a need for improvement.

### BRIEF SUMMARY OF THE INVENTION

Accordingly, it is a primary object of the present invention to provide a lithium secondary battery employing a material containing silicon as a negative electrode active material that can improve the initial charge-discharge efficiency and further enhance the charge-discharge cycle performance, by improving the negative electrode, especially by improving the conductive agent.

In order to accomplish the foregoing and other objects, the present invention provides a lithium secondary battery comprising a positive electrode; a non-aqueous electrolyte; and a negative electrode comprising a negative electrode current collector and a negative electrode mixture layer containing a negative electrode conductive agent, a negative electrode binder, and negative electrode active material particles made of a material containing silicon, the negative electrode mixture layer being sintered and disposed on the negative electrode current collector, wherein the negative electrode active material particles have an average particle size of from 5.0 μm to 15.0 μm before being charged; the negative electrode conductive agent comprises a graphite material having an average particle size of from 2.5 μm to 15.0 μm; the amount of the graphite material added is from 3 mass % to 20 mass % with respect to the negative electrode active material; and a theoretical electrical capacity ratio of the positive electrode to the negative electrode is 1.0 or less.

The present invention dramatically improves the initial performance and the cycle performance of the lithium secondary battery using a material containing silicon as a negative electrode active material.

### BRIEF DESCRIPTION OF THE DRAWINGS

FIG. 1 is a view schematically illustrating the interior of a negative electrode before and after a charge-discharge operation, the negative electrode containing negative electrode active material particles having an average particle size of 10 μm before being charged;

FIG. 2 is a view schematically illustrating the interior of a negative electrode before and after a charge-discharge operation, the negative electrode containing negative electrode active material particles having an average particle size of 20 μm before being charged;

FIG. 3 is a front view of a battery according to one preferred embodiment of the present invention; and

FIG. 4 is a cross-sectional view taken along line A-A in FIG. 3.

### DETAILED DESCRIPTION OF THE INVENTION

According to the present invention, a lithium secondary battery comprises a positive electrode, a negative electrode, and a non-aqueous electrolyte. The negative electrode comprises a negative electrode current collector and a negative electrode mixture layer. The negative electrode mixture layer contains a negative electrode conductive agent, a negative electrode binder, and negative electrode active material particles made of a material containing silicon. The negative electrode mixture layer is sintered and disposed on the negative electrode current collector. The negative electrode active material particles have an average particle size of from 5.0 μm to 15.0 μm before being charged. The negative electrode conductive agent comprises a graphite material having an average particle size of from 2.5 μm to 15.0 μm. The amount of the graphite material added is from 3 mass % to 20 mass % with respect to the negative electrode active material. The theoretical electrical capacity ratio of the positive electrode to the negative electrode is controlled to be 1.0 or less.

The just-described configuration can improve initial charge-discharge characteristics and the charge-discharge cycle performance, and as a result, can attain a battery that exhibits high energy density and outstanding cycle performance. The specific details will be explained according to the following three factors: (1) theoretical electrical capacity ratio of positive electrode to negative electrode, (2) the average particle size of negative electrode active material, and the type and amount of negative electrode conductive agent (graphite material) added, and (3) sintering and disposing the negative electrode mixture layer on a surface of the negative electrode current collector.

(1) Theoretical Electrical Capacity Ratio of Positive Electrode to Negative Electrode

In the lithium secondary battery according to the present invention, the theoretical electrical capacity ratio of the positive electrode to the negative electrode is 1.0 or less, as described above, which means that the utilization factor of the negative electrode is low. Therefore, the change in volume of silicon becomes small when it intercalates and deintercalates lithium ions, preventing the silicon from cracking during charging and discharging. As a consequence, the charge-discharge cycle performance can be improved.

Herein, the theoretical electrical capacities of the positive and negative electrodes in the lithium secondary battery of the present invention are calculated from the maximum amounts of lithium that can be theoretically intercalated by the respective active materials of the positive and negative electrodes, which are disposed facing each other in the battery.

For example, when silicon alone is used as the negative electrode active material, the theoretical capacity of silicon per unit mass is found to be 4198 mAh/g because silicon is capable of intercalating lithium ions up to Li₂₂Si₅. On the other hand, when LiCoO₂ is used as the positive electrode active material, the theoretical capacity of LiCoO₂ per unit mass is found to be 273.8 mAh/g, determined from its molecular composition.

The graphite material added as the negative electrode conductive agent is also a material theoretically capable of intercalating lithium. Nevertheless, since the lithium secondary battery of the present invention is configured so that the theoretical electrical capacity ratio of the positive electrode to the negative electrode will be 1.0 or less, the lithium intercalation starts to take place first from the silicon material, which intercalates lithium ions at a higher potential than the graphite material, and the graphite material added as the conductive agent is barely involved in the lithium intercalation. Thus, the graphite material almost entirely serves a role as the negative electrode conductive agent, so it is not taken into account in the theoretical electrical capacity of the negative electrode.

(2) Average Particle Size of Negative Electrode Active Material, and Type and Amount of Negative Electrode Conductive Agent (Graphite Material) Added

In the lithium secondary battery with the configuration as described in the above section (1), when a) the average particle size of the negative electrode active material particles is controlled, b) a graphite material is used as the negative electrode conductive agent, and c) the average particle size of the graphite material and the amount of the graphite material added are controlled, the proportion of the binder that is present on the surface of the negative electrode conductive agent will not be too large with respect to the entire binder of the negative electrode, and thus, the proportion of the binder that is present on the negative electrode active material surface will be made sufficient. Therefore, even when changes in volume of silicon occur during the lithium intercalation and deintercalation, the binding capability of the binder that is present in the negative electrode active material surface keeps the negative electrode active material particles in contact with one another. Thus, the contact capability within the negative electrode mixture layer is sufficiently ensured, and consequently, the effect of improving the current collection performance originating from the negative electrode conductive agent will be fully exhibited, improving the initial charge-discharge characteristics and the charge-discharge cycle performance. The specific details of the above conditions will be given in the following.
The reason why the average particle size of the negative electrode active material before being charged should be from 5.0 μm to 15.0 μm

If the negative electrode active material has a particle size before charging of less than 5.0 μm, the specific surface area of the negative electrode active material is accordingly large. Therefore, the amount of the negative electrode binder added also needs to be correspondingly large. Adding a large amount of negative electrode binder, however, results in an increase in the internal resistance of the negative electrode, leading to degradation in battery performance.

On the other hand, if the average particle size of the negative electrode active material before being charged exceeds 15 μm, the shift in the positional relationship between the negative electrode active material particles will be excessively large as the volume of the negative electrode active material particles changes by charge-discharge operations. Therefore, the electrical contact between the negative electrode active material particles tends to be easily lost.

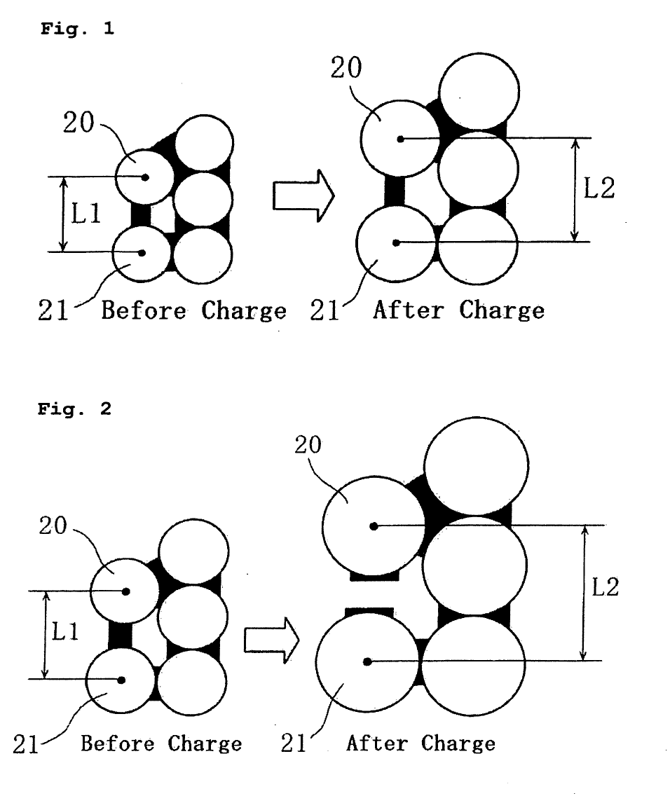

Specifically, the following two cases will be considered. In the first case, particles 20 and 21 of silicon or the like as illustrated in FIG. 1 have an average particle size of 10 μm before being charged (distance L1 between the particles 20 and 21=15 μm), while in the second case as illustrated in FIG. 2, the particles 20 and 21 of silicon or the like have an average particle size of 20 μm before being charged (distance L1 between the particles 20 and 21=30 μm). The diameter of the particles 20 and 21 of silicon or the like is assumed to expand after being charged to two times of that before being charged. Accordingly, in the case shown in FIG. 1, the distance L2 between particles 20 and 21 is approximately 30 μm after being charged, and therefore the electrical contact between the negative electrode active material particles will not be easily lost. In contrast, in the case shown in FIG. 2, the distance L2 between particles 20 and 21 is approximately 60 μm after being charged, so the electrical contact between negative electrode active material particles tends to be easily lost. For these reasons, electrical contact is easily lost between the negative electrode active material particles if the average particle size is large before being charged.

If electrical contact is lost between the particles before a surface film is sufficiently formed by charging, the surface film will no longer be formed beyond that point; therefore, decomposition of the non-aqueous electrolyte will be promoted at that portion.

On the contrary, when the negative electrode active material has an average particle size of from 5.0 μm to 15.0 μm before being charged, the specific surface area of the negative electrode active material powder will not be excessively large, and the amount of the negative electrode binder added need not be large. Therefore, the internal resistance of the negative electrode does not increase, and the shift in the positional relationship between the negative electrode active material particles will not be excessively large as the volume of the negative electrode active material particles changes by charge-discharge operations. Thus, the electrical contact within the negative electrode active material powder will not be lost.

It should be noted that the material containing silicon used as the negative electrode active material means, specifically, particles containing silicon or a silicon alloy. Examples of the silicon alloy include solid solutions of silicon and at least one other element, intermetallic compounds of silicon and at least one other element, and eutectic alloys of silicon and at least one other element.

Examples of the method for producing the alloy include arc melting, liquid quenching, mechanical alloying, sputtering, chemical vapor deposition, and baking. Specific examples of the liquid quenching include a single-roll quenching technique, a double-roller quenching technique, and various atomization techniques such as gas atomization, water atomization, and disk atomization.

The negative electrode active material used in the lithium secondary battery of the present invention may be particles containing silicon and/or silicon alloy the surfaces of which are coated with a metal or the like, for example, a transition metal such as Cu, Ni, Fe, Ti, Co, Mn and the like, or a carbon material such as graphite. Examples of the method of the coating include electroless plating, electroplating, chemical reduction techniques, evaporation, sputtering, and chemical vapor deposition.

The reason why a graphite material should be used as the negative electrode conductive agent

Among carbon materials, graphite material shows relatively high performance as a conductive agent because it has high crystallinity and high conductivity. Therefore, high current collection performance can be exhibited within the negative electrode mixture layer, and as a result, good battery performance is achieved.

It is possible to use metal materials and the like since a material with high conductivity is sufficient for the conductive agent. However, metal materials tend to have a greater specific gravity than graphite materials, causing the mass energy density of the battery to be lower. For this reason, in order to prevent the lowering of the mass energy density of the battery and at the same time achieve high current collection performance in the negative electrode mixture layer, it is preferable to use a graphite material as the conductive agent.

The graphite material used in the lithium secondary battery of the present invention should have a lattice spacing d of the (002) lattice planes of 3.37 Å or less, and a length Lc of 1000 Å or greater.
The reason why the average particle size of the graphite material should be controlled to be from 2.5 μm to 15.0 μm

If the graphite material as the negative electrode conductive agent has an average particle size of less than 2.5 μm, the proportion of the negative electrode binder that is present on the surface of the negative electrode conductive agent will be so large that the contact between the negative electrode active material particles cannot be maintained, degrading the charge-discharge characteristics. On the other hand, if the graphite material has an average particle size of greater than 15.0 μm, the particle size of the conductive agent will be too large and the thickness of the negative electrode mixture layer will be accordingly large, which means that the battery cannot attain high energy density.

In contrast, when the graphite material has an average particle size of from 2.5 μm to 15.0 μm, the proportion of the negative electrode binder that is present on the surface of the negative electrode conductive agent will not be too large in the entire negative electrode binder that is present in the negative electrode. A sufficient proportion of the binder can be kept to be present on the negative electrode active material surface, so even when a change in volume of silicon occurs during the lithium intercalation and deintercalation, the contact between the negative electrode active material particles is kept by the binding capability of the negative electrode binder that is present on the negative electrode active material surface, maintaining the contact capability within the negative electrode mixture layer. Thus, the effect of improving the current collection performance originating from the negative electrode conductive agent will be exhibited sufficiently, and the thickness of the negative electrode mixture layer will be prevented from increasing. Consequently, a high energy density battery is attained.
The reason why the amount of the graphite material added should be controlled to be from 3 mass % to 20 mass % with respect to the negative electrode active material

If the amount of the added graphite material exceeds 20 mass % with respect to the negative electrode active material, the proportion of the negative electrode binder that is present on the surface of the negative electrode conductive agent will be so great that the contact between the negative electrode active material particles cannot be maintained, and the charge-discharge characteristics will be lowered. On the other hand, if the amount of the added graphite material is less than 3 mass % with respect to the negative electrode active material, the amount of the graphite material will be too small, and the resistance inside the negative electrode will not sufficiently reduce. This means that the initial charge-discharge efficiency will not be sufficiently improved, and therefore, a high energy density battery cannot be attained.

In contrast, when the amount of the added graphite material is from 3 mass % to 20 mass %, the proportion of the negative electrode binder that is present on the surface of the negative electrode conductive agent will not be too large in the entire negative electrode binder that is present in the negative electrode, making it possible to keep a sufficient proportion of the binder present on the negative electrode active material surface. Thus, even when a change in volume of silicon occurs during the lithium intercalation and deintercalation, the contact between the negative electrode active material particles is ensured by the binding capability of the negative electrode binder present on the negative electrode active material surface, and the contact capability within the negative electrode mixture layer is also ensured. Therefore, the effect of improving the current collection performance originating from the negative electrode conductive agent is fully exhibited. Moreover, since the amount of the graphite material is adequate, the resistance in the negative electrode can be sufficiently reduced. Consequently, the initial charge-discharge efficiency is sufficiently improved, and therefore, high energy density of the battery is achieved.

(3) Sintering and Disposing the Negative Electrode Mixture Layer on a Surface of the Negative Electrode Current Collector

The negative electrode of the lithium secondary battery of the present invention is such that the negative electrode mixture layer containing a negative electrode active material powder, a negative electrode conductive agent, and a negative electrode binder is sintered and disposed on a surface of the negative electrode current collector made of a conductive metal foil. This means that adhesion is strong within the negative electrode mixture layer and between the negative electrode mixture layer and the negative electrode current collector because of the effect of sintering. Accordingly, high current collection performance is exhibited in the negative electrode. Therefore, a battery with high energy density and outstanding cycle performance can be obtained.

An example of the method for preparing such a negative electrode in which the negative electrode mixture layer is sintered on a surface of the negative electrode current collector is as follows. A slurry is prepared by uniformly mixing and dispersing negative electrode active material particles in a solution of a negative electrode binder. The prepared slurry is applied onto a surface of the negative electrode current collector, to thus dispose a negative electrode mixture layer on the surface of the negative electrode current collector. Then, the negative electrode current collector with the negative electrode mixture layer disposed on the surface thereof is sintered under a non-oxidizing atmosphere.

In this case, it is preferable that the sintering in preparing the negative electrode be carried out under an inert gas atmosphere, such as a vacuum, a nitrogen atmosphere, or an argon atmosphere. The sintering may be carried out under a reducing atmosphere such as a hydrogen atmosphere. The heat processing temperature in the sintering should preferably be lower than the melting points of the negative electrode current collector and the active material particles. For example, in the case of using a copper foil as the negative electrode current collector, it is preferable that the sintering be carried out at a temperature lower than 1083° C., which is the melting point of copper. Moreover, it is preferable that the sintering is carried out at a temperature at which the negative electrode binder does not decompose completely from the viewpoint of improvements in the current collection performance of the negative electrode. Therefore, it is more preferable that the temperature of the sintering be in the range of from 200° C. to 500° C., and still more preferably in the range of from 350° C. to 450° C. In addition, although the sintering of the negative electrode may be carried out under an oxidizing atmosphere such as air atmosphere, the temperature of the heat process for the sintering should preferably be 300° C. or lower in this case. Furthermore, the sintering may be performed by a discharge plasma sintering technique or a hot pressing technique.

In the lithium secondary battery of the present invention, it is preferable that the graphite material have a BET specific surface area of 15 m²/g or less.

In addition to controlling the average particle sizes of the negative electrode active material powder and the negative electrode conductive agent as well as the amount of the added negative electrode conductive agent to be in the ranges explained above, controlling the BET specific surface area of the graphite material as the negative electrode conductive agent to be in the foregoing range further prevents the proportion of the negative electrode binder that is present on the surface of the negative electrode conductive agent from becoming too large, further improving the current collection performance within the negative electrode mixture layer. Therefore, high initial charge-discharge efficiency and good charge-discharge cycle performance can be attained, and a battery with high energy density and outstanding cycle performance can be obtained.

In the lithium secondary battery of the present invention, it is preferable that the negative electrode binder comprise polyimide.

Polyimide resin has a high mechanical strength and good elasticity. Therefore, the use of polyimide resin allows the negative electrode mixture layer to change in shape according to the change in volume of the silicon negative electrode active material and prevents the negative electrode binder from being destroyed even when changes in volume of the silicon active material occur at the time of lithium intercalation and deintercalation. Consequently, the current collection performance in the electrode is maintained, and outstanding charge-discharge cycle performance can be obtained.

It is preferable that the negative electrode binder remain in the negative electrode mixture layer without being decomposed even after the heat treatment for sintering and disposing the negative electrode mixture layer on the negative electrode current collector surface. The reason is that if the negative electrode binder is completely decomposed after the sintering, the binding effect of the binder will be lost and the current collection performance in the electrode greatly lowered, resulting in very poor charge-discharge performance. From this viewpoint as well, it is preferable to use polyimide, which has high heat resistance, as the negative electrode binder.

In the lithium secondary battery of the present invention, it is preferable that the polyimide have a glass transition temperature of 350° C. or lower.

When the heat treatment is carried out at a temperature higher than the glass transition temperature of the polyimide, which is thermoplastic, in the sintering and disposing of the negative electrode mixture layer on the negative electrode current collector surface, the polyimide thermally bonds with the negative electrode active material particles, the conductive agent particles, and the negative electrode current collector, thereby further enhancing the adhesion within the negative electrode mixture layer and the adhesion between the negative electrode mixture layer and the negative electrode current collector. As a consequence, the current collection performance in the electrode greatly improves, making it possible to obtain higher initial charge-discharge efficiency and better charge-discharge cycle performance. Moreover, it is also possible to expect an anchoring effect of polyimide, that is, the polyimide entering the surface irregularities in the negative electrode active material particles, the conductive agent particles, and the negative electrode current collector surface. Thus, the foregoing advantageous effects will be exhibited further. Nevertheless, as mentioned above, it is preferable that the heat treatment for sintering the negative electrode be carried out at a temperature range of from 350° C. to 450° C.

For the above reasons, it is preferable that the polyimide have a glass transition temperature of 350° C. or lower.

In the lithium secondary battery of the present invention, it is preferable that the negative electrode active material consist of only silicon.

The reason is that the capacity of the lithium secondary battery is maximized when the negative electrode active material consists of only silicon.

Additional Notes about the Primary Components of the Battery Notes about the Positive Electrode

(a) It is preferable that the positive electrode in the lithium secondary battery of the present invention be such that a positive electrode mixture layer containing a positive electrode active material, a positive electrode conductive agent, and a positive electrode binder is disposed on a surface of a positive electrode current collector made of a conductive metal foil.

(b) A preferable positive electrode active material in the lithium secondary battery of the present invention is a lithium-transition metal composite oxide. Examples of the lithium-transition metal composite oxide include LiCoO₂, LiNiO₂, LiMn₂O₄, LiMnO₂, LiCo_{0.5}Ni_{0.5}O₂, and LiNi_{0.33}Co_{0.33}Mn_{0.34}O₂. Particularly preferable are LiCoO₂, and layered-structure lithium-transition metal composite oxides containing Li, Ni, Mn, and Co.

(c) It is preferable that the BET specific surface area of the lithium-transition metal composite oxide be 3 m²/g or less. The reason is that, if the BET specific surface area of the lithium-transition metal composite oxide exceeds 3 m²/g, the reactivity thereof with the non-aqueous electrolyte will be high because the contact area of the lithium-transition metal composite oxide with the non-aqueous electrolyte is too large. Therefore, side reactions, such as gas generation originating from the decomposition reaction of the non-aqueous electrolyte, tend to occur more easily, degrading the charge-discharge characteristics.

(d) It is preferable that the average particle size of the lithium-transition metal composite oxide (average particle size of secondary particles) be 20 μm or less. The reason is that, if the average particle size exceeds 20 μm, the distance of diffusion of the lithium within the particles of the lithium-transition metal composite oxide will be too large, degrading the charge-discharge cycle performance.

(e) In the positive electrode of the lithium secondary battery of the present invention, it is preferable that the positive electrode mixture layer contain a positive electrode conductive agent. Various known conductive agents may be used as the positive electrode conductive agent. Preferable examples include a conductive carbon material such as a graphite material powder, for example, natural and artificial graphite, and carbon black powder, for example, Ketjen Black, acetylene black, and the like, and particularly preferable examples are acetylene black and Ketjen Black.

It is preferable that the amount of the positive electrode conductive agent with respect to the total amount of the positive electrode mixture layer be from 1 mass % to 5 mass %. The reason is as follows. If the amount of the positive electrode conductive agent with respect to the total amount of the positive electrode mixture layer is less than 1 mass %, the amount of the conductive agent is so small that a conductive network cannot be formed sufficiently around the positive electrode active material. Therefore, the current collection performance within the positive electrode mixture layer lowers and thus the charge-discharge performance degrades. On the other hand, if the amount of the positive electrode conductive agent with respect to the total amount of the positive electrode mixture layer exceeds 5 mass %, the amount of the conductive agent will be so large that the binder to bond the conductive agent is consumed. This means that the adherence between the positive electrode active material particles is degraded and the adherence of the positive electrode active material with the positive electrode current collector also is degraded. Consequently, the positive electrode active material tends to peel off easily, and the charge-discharge performance degrades.

(f) Various known binders may be used as the positive electrode binder without limitation as long as the binders do not dissolve in the solvent used for the non-aqueous electrolyte in the present invention. Preferable examples include fluororesins such as polyvinylidene fluoride, polyimide-based resins, and polyacrylonitriles.

It is preferable that the amount of the positive electrode binder be from 1 mass % to 5 mass % with respect to the positive electrode mixture layer. The reason is as follows. If the amount of the positive electrode binder is less than 1 mass % with respect to the positive electrode mixture layer, the contact areas between the positive electrode active material particles will increase, reducing the contact resistance. Nevertheless, the adherence between the positive electrode active material particles and the adherence of the positive electrode active material with the positive electrode current collector will become poor because the amount of the binder is too small, so the positive electrode active material tends to peel off easily, consequently lowering the charge-discharge performance. On the other hand, if the amount of the positive electrode binder exceeds 5 mass % with respect to the positive electrode mixture layer, the adherence between the positive electrode active material particles and the adherence of the positive electrode active material with the positive electrode current collector can improve. Nevertheless, the amount of the binder is so large that the contact areas between the positive electrode active material particles will be too small, increasing the contact resistance and thus degrading charge-discharge performance.

(g) Various conductive metal foils may be used as the positive electrode current collector without limitation, as long as they do not dissolve in the non-aqueous electrolyte and are stable at the potential applied to the positive electrode during charging and discharging. A preferable example is aluminum foil.

(h) It is preferable that the density of the positive electrode mixture layer be 3.0 g/cm³ or greater. The reason is that, when the density of the positive electrode mixture layer is 3.0 g/cm³ or greater, contact areas within the positive electrode active material increase and current collection performance within the positive electrode mixture layer improves, making it possible to obtain good charge-discharge performance.

Notes about the Non-aqueous Electrolyte

(a) Examples of the solvent of the non-aqueous electrolyte include, but are not particularly limited to, cyclic carbonates such as ethylene carbonate, propylene carbonate, butylene carbonate, and vinylene carbonate; chain carbonates such as dimethyl carbonate, ethyl methyl carbonate, and diethyl carbonate; esters such as methyl acetate, ethyl acetate, propyl acetate, methyl propionate, ethyl propionate, and y-butyrolactone; ethers such as 1,2-dimethoxyethane, 1,2-diethoxyethane, tetrahydrofuran, 1,2-dioxane, and 2-methyltetrahydrofuran; nitrites such as acetonitrile; and amides such as dimethylformamide. These solvents may be used either alone of in combination. Particularly preferred is a mixed solvent of a cyclic carbonate and a chain carbonate.

(b) Examples of the solute of the non-aqueous electrolyte in the present invention include, but are not particularly limited to lithium compounds represented by the chemical formula LiXF_{y} (wherein X is P, As, Sb, B, Bi, Al, Ga, or In; and either y is 6 when X is P, As, or Sb; or y is 4 when X is B, Bi, Al, Ga, or In), such as LiPF₆, LiBF₄, LiAsF₆; as well as lithium compounds such as LiCF₃SO₃, LiN (CF₃SO₂)₂, LiN (C₂F₅SO₂)₂, LiN (CF₃SO₂) (C₄F₉SO₂), LiC (CF₃SO₂)₃, LiC(C₂F₅SO₂)₃, LiClO₄, Li₂B₁₀Cl₁₀, and Li₂B₁₂Cl₁₂. Among these, LiPF₆ is particularly preferred.

(c) In the present invention, it is preferable that carbon dioxide be dissolved in the non-aqueous electrolyte. Carbon dioxide dissolved in the non-aqueous electrolyte enables the lithium intercalation/deintercalation reaction to take place smoothly on the surfaces of the positive and negative electrode active materials, achieving even better charge-discharge characteristics.

(d) Examples of the non-aqueous electrolyte include gelled polymer electrolytes in which an electrolyte solution is impregnated in a polymer electrolyte such as polyethylene oxide and polyacrylonitrile, as well as inorganic solid electrolytes such as LiI and Li₃N. Various non-aqueous electrolytes may be used as the non-aqueous electrolyte in the present invention without limitation as long as the lithium compound as the solute for attaining lithium-ion conductivity and the solvent for dissolving and retaining the solute do not decompose during charge-discharge operations or storage of the battery.

Notes about the Negative Electrode

(a) In the negative electrode, it is preferable that the distribution of particle size of the negative electrode active material be as narrow as possible. If the distribution of particle size is wide, there will be a large difference in the absolute amount of the expansion and shrinkage in volume associated with lithium intercalation and deintercalation among the active material particles that greatly vary in particle size, causing strain in the negative electrode mixture layer. As a result, destruction in the negative electrode binder will occur, degrading the current collection performance in the electrode and thereby lowering the charge-discharge performance.

(b) It is preferable that the amount of the negative electrode binder be 5% or greater of the total mass of the negative electrode mixture layer, and that the volume of the negative electrode binder be 5% or greater of the total volume of the negative electrode mixture layer. If the amount of the negative electrode binder is less than 5% of the total mass of the negative electrode mixture layer, or the volume of the negative electrode binder is less than 5% of the total volume of the negative electrode mixture layer, the adherence within the electrode obtained by the negative electrode binder will be insufficient because the amount of the negative electrode binder is too small relative to the negative electrode active material particles. On the other hand, if the amount of the negative electrode binder is too large, the resistance within the electrode will be great, making the initial charging difficult. Therefore, it is preferable that the amount of the negative electrode binder be 50% or less of the total mass of the negative electrode mixture layer, and that the volume of the negative electrode binder be 50% or less of the total volume of the negative electrode mixture layer. It should be noted that the total volume of the negative electrode mixture layer means the total of the volumes of the materials such as the negative electrode active material and the negative electrode binder, and that it does not include the volume of voids in the mixture layer if such voids exist in the mixture layer.

(c) It is preferable that the conductive metal foil as the negative electrode current collector have a surface roughness Ra of 0.2 μm or greater on the surface on which the negative electrode mixture layer is disposed. When using a conductive metal foil having such a surface roughness Ra as the negative electrode current collector, the binder gets into the portions of the current collector surface in which the surface irregularities exist, exerting an anchoring effect and thereby providing strong adherence between the binder and the current collector. As a result, it is possible to prevent the peeling-off of the negative electrode mixture layer from the negative electrode current collector, which is due to the expansion and shrinkage in volume of the active material particles that are associated with the lithium intercalation and deintercalation.

In the case that the negative electrode mixture layer is disposed on both surfaces of the current collector, it is preferable that both surfaces of the negative electrode have a surface roughness Ra of 0.2 μm or greater. To provide the current collector with a surface roughness Ra of 0.2 μm or greater, the conductive metal foil may be subjected to a roughening process. Examples of the roughening process include plating, vapor deposition, etching, and polishing. Plating and vapor deposition are techniques in which a surface of a metal foil is roughened by forming a thin film layer with irregularities on the metal foil surface. Examples of the plating include electroplating and electroless plating. Examples of the vapor deposition include sputtering, chemical vapor deposition, and evaporation. In addition, examples of the etching include such techniques as physical etching and chemical etching. Examples of the polishing include polishing by sandpaper and polishing by blasting.

It is preferable that the just-mentioned surface roughness Ra and mean spacing of local peaks S have a relationship 100 Ra≧S. Surface roughness Ra and mean spacing of local peaks S are defined in Japanese Industrial Standards (JIS B 0601-1994) and can be measured by, for example, a surface roughness meter.

The negative electrode current collector made of a conductive metal foil may be, for example, a foil of a metal such as copper, nickel, iron, titanium, or cobalt, or may be an alloy foil formed of a combination thereof.

(d) It is particularly preferable that the conductive metal foil current collector have a high mechanical strength. The reason is as follows. Even if the negative electrode current collector experiences a stress due to changes in volume of the negative electrode active material containing silicon during the lithium intercalation and deintercalation, the stress will be alleviated, and destruction or plastic deformation of the negative electrode current collector will not occur when the negative electrode current collector has a high mechanical strength. Consequently, the negative electrode mixture layer is prevented from peeling off from the negative electrode current collector, and the current collection performance in the electrode is ensured. Thus, good charge-discharge characteristics can be obtained.

(e) Although not particularly limited, the thickness of the negative electrode current collector made of a conductive metal foil is preferably within the range of from 10 μm to 100 μm.

In addition, the upper limit of the surface roughness Ra of the conductive metal foil negative electrode current collector in the present invention is not particularly limited. However, the upper limit of the surface roughness Ra should practically be 10 μm or less because it is preferred that the thickness of the conductive metal foil be within the range of from 10 μm to 100 μm as noted above.

(f) In the negative electrode, it is preferable that, where the thickness of the negative electrode mixture layer is denoted as X and the thickness of the negative electrode current collector as Y, the thickness X of the negative electrode mixture layer, the thickness Y of the negative electrode current collector, and the surface roughness Ra satisfy the relations 5Y≧X and 250 Ra≧X. If the thickness X of the negative electrode mixture layer exceeds 5Y or 250 Ra, the expansion and shrinkage in volume of the negative electrode mixture layer during charging and discharging are so great that the adherence between the negative electrode mixture layer and the negative electrode current collector cannot be maintained depending on the irregularities of the current collector surface, and the negative electrode mixture layer may peel off from the negative electrode current collector.

Although not particularly limited, the thickness X of the negative electrode mixture layer is preferably 1000 μm or less, and more preferably is in the range of from 10 μm to 100 μm.

(g) It is preferable that the negative electrode in the present invention be fabricated by uniformly mixing and dispersing particles containing silicon and/or a silicon alloy, serving as the negative electrode active material, into a solution of the negative electrode binder to thereby prepare a negative electrode mixture slurry, and applying the resultant negative electrode mixture slurry onto a surface of a conductive metal foil, serving as the negative electrode current collector. The negative electrode mixture layer thus produced using the slurry in which active material particles are uniformly mixed and dispersed in a negative electrode binder solution forms a structure in which the negative electrode binder is uniformly distributed around the active material particles. This makes it possible to exploit maximum benefit from the mechanical properties of the negative electrode binder, to attain high electrode strength, and to thereby obtain good charge-discharge cycle performance.

Notes about the Overall Battery Construction

It is preferable that the lithium secondary battery of the present invention have a configuration in which a non-aqueous electrolyte and an electrode assembly formed by opposing the positive electrode and the negative electrode across a separator are accommodated in a battery case. Examples of the structure of the electrode assembly include a layered structure, a flat-shaped structure, and a cylindrical structure.

Hereinbelow, the present invention is described in further detail based on preferred embodiments thereof. It should be construed, however, that the present invention is not limited to the following preferred embodiments and various changes and modifications are possible without departing from the scope of the invention.

Preparation of Positive Electrode

Li₂CO₃ and CoCO₃ were used as starting materials. The starting materials were weighed so that the atomic ratio Li:Co became 1:1, followed by mixing them in a mortar. Thereafter, the resultant mixture was baked in an air atmosphere at 800° C. for 24 hours, to thus obtain a baked substance of lithium-cobalt composite oxide (lithium-transition metal composite oxide) represented as LiCoO₂. Next, the resultant baked substance was pulverized in a mortar into particles with an average particle size of about 7 μm. The BET specific surface area of the LiCoO₂ was 0.49 m²/g.

Subsequently, the resultant LiCoO₂ powder as a positive electrode active material, a carbon material powder as a positive electrode conductive agent, and polyvinylidene fluoride as a positive electrode binder were added to N-methyl-2-pyrrolidone as a dispersion medium. The mixture was then kneaded to obtain a positive electrode mixture slurry. The weight ratio of the LiCoO₂ powder, the carbon material powder, and the polyvinylidene fluoride was 94:3:3.

Thereafter, the resultant positive electrode mixture slurry was applied onto one side of an aluminum foil (thickness: 15 μm) as a positive electrode current collector, and was then dried and pressure-rolled to form a positive electrode mixture layer. Lastly, the resultant material was cut into a 20 mm×20 mm square shape, and an aluminum metal piece serving as a positive electrode current collector tab was attached thereto. Thus, a positive electrode was prepared. The amount of the positive electrode mixture layer formed on the positive electrode current collector was 26.50 mg/cm².

Preparation of Negative Electrode

First, a silicon powder (average particle size: 5.5 μm, purity: 99.9%) as the negative electrode active material, a graphite powder (average particle size: 9.5 μm, BET specific surface area: 6.5 m²/g) as the negative electrode conductive agent, and thermoplastic polyimide (glass transition temperature: 190° C., density: 1.1 g/cm³) as the negative electrode binder were added to a N-methyl-2-pyrrolidone solution as a dispersion medium and were kneaded to prepare a negative electrode mixture slurry. The mass ratio of the silicon powder, the graphite powder, and the thermoplastic polyimide was set at 90:13.5:10. The average particle sizes of the silicon powder and the graphite powder were determined by a laser diffraction method.

Next, an electrolytic copper foil (thickness: 35 μm), one side of which had been roughened (surface roughness Ra: 1.0 μm), was prepared as the negative electrode current collector, and the negative electrode mixture slurry prepared in the foregoing manner was applied onto the roughened side of the copper foil and then dried. The amount of the mixture layer on the negative electrode current collector was 3.18 mg/cm². Subsequently, the resultant material was cut out into a 25 mm×30 mm rectangular shape, then pressure-rolled, and sintered by baking it under an argon atmosphere at 400° C. for 1 hour. Lastly, a nickel metal piece serving as the negative electrode current collector tab was attached to an edge of the sintered material thus obtained. Thus, a negative electrode was prepared.

Preparation of Non-aqueous Electrolyte Solution

LiPF₆ was dissolved at a concentration of 1 mole/liter into a mixed solvent of a 3:7 volume ratio of ethylene carbonate and diethyl carbonate. Carbon dioxide was blown into the resultant solution at 25° C. to dissolve carbon dioxide to the saturation point. Thus, a non-aqueous electrolyte solution was prepared.

Preparation of Battery

A porous polyethylene separator having a thickness of 22 μm, a porosity of 47%, and an air permeability of 100 (sec/100 cc) (the air permeability is measured according to JIS P8117) (time required for 100 mL air to pass through a separator having an area of 645 mm²) was interposed between the positive electrode and the negative electrode prepared as described above to prepare an electrode assembly. The electrode assembly and the non-aqueous electrolyte solution were filled into a battery case made of an aluminum laminate under an atmospheric pressure argon atmosphere at room temperature. Thus, a secondary battery was prepared.

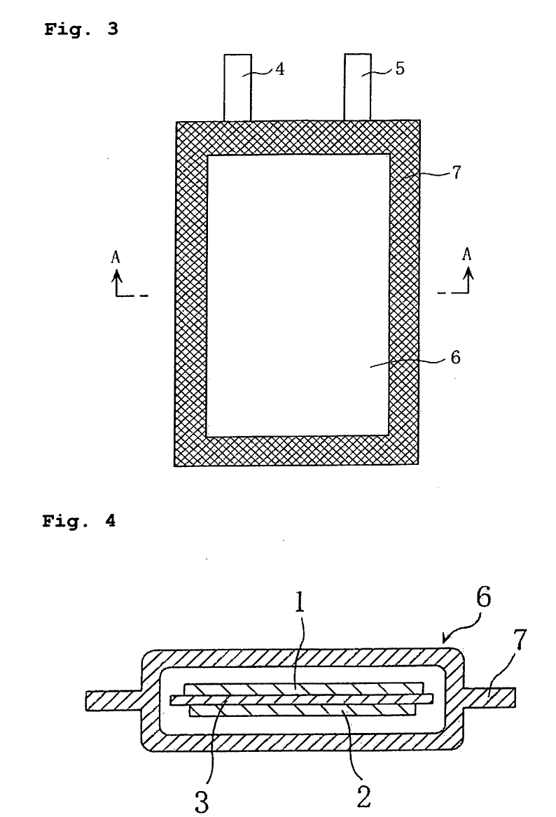

The specific structure of the lithium secondary battery was as follows. As illustrated in FIGS. 3 and 4, a positive electrode 1 and a negative electrode 2 are disposed so as to oppose each other with a separator 3 interposed therebetween, whereby a power-generating element is constituted by the positive electrode 1, the negative electrode 2, the separator 3, and the non-aqueous electrolyte solution. The positive electrode 1 and the negative electrode 2 are connected to the positive electrode current collector tab 4 made of aluminum metal and the negative electrode current collector tab 5 made of nickel metal, respectively, forming a structure capable of charge and discharge as a secondary battery. The power-generating element made of the positive electrode 1, the negative electrode 2, and the separator 3 is accommodated in a space of an aluminum laminate battery case 6 having a sealed part 7 at which end parts of the aluminum laminate were heat sealed.

Calculation of Theoretical Electrical Capacity Ratio of Positive Electrode to Negative Electrode

With the battery prepared in the above-described manner, the theoretical electrical capacity ratio of the positive electrode to the negative electrode (hereafter also referred to as “positive electrode/negative electrode theoretical electrical capacity ratio”) was obtained from equation 1 below. In the following equation 1, the theoretical electrical capacity of the negative electrode active material composed of silicon powder was determined to be 4198 mAh/g and the theoretical electrical capacity of the positive electrode active material composed of LiCoO₂ powder was determined to be 273.8 mAh/g.
Theoretical electrical capacity ratio of positive electrode to negative electrode=Mass of positive electrode active material per unit area (g/cm²)× Theoretical electrical capacity of positive electrode active material (mAh/g)/Mass of negative electrode active material per unit area (g/cm²)× Theoretical electrical capacity of negative electrode active material (mAh/g) (Eq. 1)

Thus, the positive electrode/negative electrode theoretical electrical capacity ratio was found to be 0.64.

### EXAMPLES

### First Embodiment

### Example A1

A lithium secondary battery was fabricated according to the above-described preferred embodiment of the invention.

The battery thus fabricated is hereinafter referred to as Battery A1 of the invention.

### Examples A2 and A3

Lithium secondary batteries were fabricated in the same manner as in Example A1, except that the particle sizes of the negative electrode active material Si powder (before being charged) were 7.5 μm and 10.0 μm, respectively.

The batteries thus fabricated are hereinafter referred to as Batteries A2 and A3 of the invention, respectively.

### Comparative Examples Z1 and Z2

Lithium secondary batteries were fabricated in the same manner as in Example A1, except that the particle sizes of the negative electrode active material Si powder (before being charged) were 2.5 μm and 20.0 μm, respectively.

The batteries thus fabricated are hereinafter referred to as Comparative Batteries Z1 and Z2, respectively.

Experiment

Batteries A1 to A3 of the invention and Comparative Batteries Z1 and Z2 were charged and discharged under the charge-discharge conditions set forth below to study their initial performance (charge-discharge efficiency at the first cycle) and cycle performance (cycle life), obtained by the following equation 2. The results are shown in Table 1 below.

It should be noted that cycle life herein is the number of cycles obtained until the discharge capacity of a battery lowers to 85% of the discharge capacity obtained at the first cycle. The values of cycle life for the batteries are shown as indices wherein the cycle life of Battery A1 of the invention is taken as 100.

Charge-discharge Conditions

Charge Conditions

The batteries were charged with a constant current of 17 mA until the battery voltage reached 4.2 V. Thereafter, the batteries were constant voltage charged while keeping the battery voltage at 4.2 V until the current value reached 0.85 mA. The temperature was 25° C.

Discharge Conditions

The batteries were discharged with a current of 17 mA until the battery voltage reached 2.75 V. The temperature was 25° C.
Charge-discharge efficiency at the first cycle (%)=(Discharge capacity at the first cycle/Charge capacity at the first cycle)×100 Eq. 2

TABLE 1

| | | Negative electrode conductive agent | | | | | | |
|---|---|---|---|---|---|---|---|---|
| | Si | | | | Amount | Theoretical | | |
| | powder | | | BET | added | capacity ratio | | |
| | average | | Average | specific | (with | of positive | | |
| | particle | | particle | surface | respect to | electrode to | | |
| | size | | size | area | Si powder, | negative | Initial | Cycle |
| Battery | (μm) | Material | (μm) | (m²/g) | mass %) | electrode | performance | life |
| Z1 | [symbol] | Graphite | 9.5 | 6.5 | 15 | 0.64 | 92 | 43 |
| A1 | [symbol] | Graphite | 9.5 | 6.5 | 15 | 0.64 | 100 | 100 |
| A2 | [symbol] | Graphite | 9.5 | 6.5 | 15 | 0.64 | 99 | 148 |
| A3 | [symbol] | Graphite | 9.5 | 6.5 | 15 | 0.64 | 98 | 187 |
| Z2 | [symbol] | Graphite | 9.5 | 6.5 | 15 | 0.64 | 74 | 67 |

Note:
The values of initial performance and cycle performance are expressed in relative values to those of Battery A1, which are taken to be 100.
The values shown in bold italics are the primary variables.

As clearly seen from Table 1, it is demonstrated that Batteries A1 to A3 of the invention, in which the negative electrode active material Si powder had an average particle size of from 5.5 μm to 10.0 μm, were superior in initial performance and cycle performance to Comparative Battery Z1, in which the Si powder had an average particle size of 2.5 μm, and Comparative Battery Z2, in which the Si powder had an average particle size of 20.0 μm.

It is believed that the above results are attributable to the following reasons.

When the Si powder has an average particle size of 2.5 μm as in Comparative Battery Z1, the specific surface area of the Si powder is large and the amount of the negative electrode binder added needs to be correspondingly large. However, in Comparative Battery Z1, because the amount of the negative electrode binder is not so large, the binding capability within the negative electrode mixture layer becomes poor. If the amount of the negative electrode binder is increased, the internal resistance of the negative electrode will increase, although the binding capability will improve. On the other hand, when the Si powder has an average particle size of 20.0 μm as in Comparative Battery Z2, the shift in the positional relationship between the particles of the Si powder will be too large when a change in volume of the Si powder occurs by charge-discharge operations, and the electrical contact between the particles of the Si powder tends to be easily lost.

In contrast, when the Si powder has an average particle size of from 5.5 μm to 10.0 μm as in Batteries A1 to A3 of the invention, the specific surface area of the Si powder is not so large and the amount of the negative electrode binder added need not be large. Consequently, the binding capability within the negative electrode mixture layer will not degrade, and the internal resistance of the negative electrode can be prevented from increasing. Moreover, the shift in the positional relationship between the particles of the Si powder will not become large when a change in volume of the Si powder occurs due to charge-discharge operations, and therefore, the electrical contact between the particles of the Si powder is prevented from being lost.

It should be noted that it was confirmed that although not shown in Table 1, the batteries exhibited good initial performance and good cycle performance when the Si powder has an average particle size of from 5 μm to 15 μm.

From the viewpoint of BET specific surface area, it was also confirmed that it is preferable that the graphite material have a BET specific surface area of 15 m²/g or less.

### Second Embodiment

### Examples B1 to B4

Lithium secondary batteries were fabricated in the same manner as in Example A1 of the first embodiment, except that the particle sizes of the negative electrode conductive agent, graphite, were 3.4 μm (BET specific surface area: 12.5 m²/g), 3.7 μm (BET specific surface area: 14.2 m²/g), 5.3 μm (BET specific surface area: 10.5 m²/g), and 12.0 μm (BET specific surface area: 7.7 m²/g).

The batteries thus fabricated are hereinafter referred to as Batteries B1 to B4 of the invention, respectively.

### Comparative Example Y

A lithium secondary battery was fabricated in the same manner as in Example A1 of the first embodiment, except that the particle size of the negative electrode conductive agent, graphite, was 20.0 μm (BET specific surface area: 5.4 m²/g)

The battery thus fabricated is hereinafter referred to as Comparative Battery Y.

Experiment

Batteries B1 to B4 of the invention and Comparative Battery Y were charged and discharged under the same charge-discharge conditions set out in the experiment of the first embodiment, and their initial performance and cycle performance were studied in the same manner as described in the experiment of the first embodiment. The results are shown in Table 2 below. Table 2 also shows the experimental results for Battery A1 of the invention.

TABLE 2

| | | Negative electrode conductive agent | | | | | | |
|---|---|---|---|---|---|---|---|---|
| | | | | | Amount | Theoretical | | |
| | Si | | | | added | capacity | | |
| | powder | | | BET | (with | ratio of | | |
| | average | | Average | specific | respect | positive | | |
| | particle | | particle | surface | to Si | electrode to | | |
| | size | | size | area | powder, | negative | Initial | Cycle |
| Battery | (μm) | Material | (μm) | (m²/g) | mass %) | electrode | performance | life |
| B1 | 5.5 | Graphite | [symbol] | 12.5 | 15 | 0.64 | 99 | 97 |
| B2 | 5.5 | Graphite | [symbol] | 14.2 | 15 | 0.64 | 100 | 95 |
| B3 | 5.5 | Graphite | [symbol] | 10.5 | 15 | 0.64 | 99 | 94 |
| A1 | 5.5 | Graphite | [symbol] | 6.5 | 15 | 0.64 | 100 | 100 |
| B4 | 5.5 | Graphite | [symbol] | 7.7 | 15 | 0.64 | 97 | 105 |
| Y | 5.5 | Graphite | [symbol] | 5.4 | 15 | 0.64 | 87 | 89 |

Note:
The values of initial performance and cycle performance are expressed in relative values to those of Battery A1, which are taken to be 100.
The values shown in bold italics are the primary variables.

As clearly seen from Table 2, Batteries B1 to B4 of the invention as well as Battery A1 of the invention, in which the negative electrode conductive agent, graphite powder, had an average particle size of from 3.4 μm to 12.0 μm, were superior in initial performance and cycle performance to Comparative Battery Y, in which the graphite powder had an average particle size of 20.0 μm.

It is believed that the above results are attributable to the following reasons.

In both cases, the amounts of graphite powder added to the negative electrode mixture layer are the same. However, when the graphite powder has an average particle size of 20.0 μm, the number of particles in the graphite powder is smaller than those with smaller average particle sizes, and therefore, a conductive network of graphite powder tends not to form between the negative electrode active material particles. Consequently, the current collection performance in the negative electrode mixture layer lowers, degrading the charge-discharge characteristics. In contrast, when the average particle size of the graphite powder is from 3.4 μm to 12.0 μm as in Batteries B1 to B4 of the invention as well as Battery A1 of the invention, a conductive network of graphite particles forms between the negative electrode active material particles since the particle size of the conductive agent is not so large. As a consequence, the current collection performance in the negative electrode mixture layer will not degrade.

It should be noted that it was confirmed that although not shown in Table 2, the batteries exhibited good initial performance and good cycle performance when the graphite powder has an average particle size of from 2.5 μm to 15.0 μm. It should also be noted that the reason why the average particle size of the graphite material is controlled to be 2.5 μm or greater is that, if the average particle size of the graphite material is less than 2.5 μm, the contact between the negative electrode active material particles cannot be maintained because the proportion of the negative electrode binder that is present on the surface of the negative electrode conductive agent will be too large, and the charge-discharge characteristics will be lowered.

### Third Embodiment

### Examples C1 to C3

Lithium secondary batteries were fabricated in the same manner as in Example A1 of the first embodiment, except that the amounts of the added graphite, serving as the negative electrode conductive agent, were set at 5 mass %, 10 mass %, and 20 mass %, respectively, with respect to the negative electrode active material.

The batteries thus fabricated are hereinafter referred to as Batteries C1 to C3 of the invention, respectively.

### Comparative Example X1

A lithium secondary battery was fabricated in the same manner as in Example A1 of the first embodiment, except that no graphite as a negative electrode conductive agent was added.

The battery thus fabricated is hereinafter referred to as Comparative Battery X1.

### Comparative Examples X2 and X3

Lithium secondary batteries were fabricated in the same manner as in Example A1 of the first embodiment, except that the amounts of graphite added, serving as the negative electrode conductive agent, were set at 1 mass % and 30 mass % with respect to the negative electrode active material, respectively.

The batteries thus fabricated are hereinafter referred to as Comparative Batteries X2 and X3, respectively.

Experiment

Batteries C1 to C3 of the invention and Comparative Batteries X1 to X3 were charged and discharged under the same charge-discharge conditions set out in the experiment of the first embodiment, and their initial performance and cycle performance were studied in the same manner as described in the experiment of the first embodiment. The results are shown in Table 3 below. Table 3 also shows the experimental results for Battery A1 of the invention.

TABLE 3

| | | Negative electrode conductive agent | | | | | | |
|---|---|---|---|---|---|---|---|---|
| | | | | | Amount | Theoretical | | |
| | Si | | | | added | capacity | | |
| | powder | | | BET | (with | ratio of | | |
| | average | | Average | specific | respect | positive | | |
| | particle | | particle | surface | to Si | electrode to | | |
| | size | | size | area | powder, | negative | Initial | Cycle |
| Battery | (μm) | Material | (μm) | (m²/g) | mass %) | electrode | performance | life |
| X1 | 5.5 | — | — | — | [symbol] | 0.64 | 88 | 87 |
| X2 | 5.5 | Graphite | 9.5 | 6.5 | [symbol] | 0.64 | 89 | 89 |
| C1 | 5.5 | Graphite | 9.5 | 6.5 | [symbol] | 0.64 | 97 | 95 |
| C2 | 5.5 | Graphite | 9.5 | 6.5 | [symbol] | 0.64 | 99 | 98 |
| A1 | 5.5 | Graphite | 9.5 | 6.5 | [symbol] | 0.64 | 100 | 100 |
| C3 | 5.5 | Graphite | 9.5 | 6.5 | [symbol] | 0.64 | 104 | 93 |
| X3 | 5.5 | Graphite | 9.5 | 6.5 | [symbol] | 0.64 | 98 | 77 |

Note:
The values of initial performance and cycle performance are expressed in relative values to those of Battery A1, which are taken to be 100.
The values shown in bold italics are the primary variables.

As clearly seen from Table 3, Batteries C1 to C3 of the invention as well as Battery A1 of the invention, in which the amounts of the added negative electrode conductive agent, graphite powder, were from 5 mass % to 20 mass %, were superior in both initial performance and cycle performance to Comparative Battery X2, in which the amount of the added graphite powder was 1 mass %, and was superior in cycle performance to Comparative Battery X3, in which the amount of the added graphite powder was 30 mass

It is believed that the above results are attributable to the following reasons.

When no graphite powder is added as in Comparative Battery X1 or the amount of the added graphite powder is too small, like 1 mass % as in Comparative Battery X2, the internal resistance of the negative electrode will not be reduced sufficiently. On the other hand, when the amount of the added graphite powder is 30 mass % as in Comparative Battery X3, the proportion of the negative electrode binder that is present on the surface of the negative electrode conductive agent will be too large, and the contact between the negative electrode active material particles cannot be maintained.

In contrast, when the amount of the added graphite material is from 3 mass % to 20 mass % as in Batteries C1 to C3 of the invention, the proportion of the negative electrode binder that is present on the surface of the negative electrode conductive agent will not be too large in the entire negative electrode binder that is present within the negative electrode, and the proportion thereof that is present on the negative electrode active material surface is sufficiently ensured. Consequently, even when a change in volume of silicon occurs during the lithium intercalation and deintercalation, the contact between the negative electrode active material particles is ensured by the binding capability of the negative electrode binder that is present on the negative electrode active material surface, so the contact capability within the negative electrode mixture layer is also ensured. Thus, the effect of improving the current collection performance due to the negative electrode conductive agent can be fully exhibited, and the internal resistance of the negative electrode can be sufficiently reduced since the amount of the graphite material is not too small.

### Fourth Embodiment

### Examples D1 and D2

Lithium secondary batteries were fabricated in the same manner as in Example A1 of the first embodiment, except that their positive electrode/negative electrode theoretical electrical capacity ratios were set at 1.00 and 0.81, respectively.

The batteries thus fabricated are hereinafter referred to as Batteries D1 and D2 of the invention, respectively.

### Comparative Example W

A lithium secondary battery was fabricated in the same manner as in Example A1 of the first embodiment, except that the positive electrode/negative electrode theoretical electrical capacity ratio was set at 1.46.

The battery thus fabricated is hereinafter referred to as Comparative Battery W.

Experiment

Batteries D1 and D2 of the invention and Comparative Battery W were charged and discharged under the same charge-discharge conditions set out in the experiment of the first embodiment, and their initial performance and cycle performance were studied in the same manner as described in the experiment of the first embodiment. The results are shown in Table 4 below. Table 4 also shows the experimental results for Battery A1 of the invention.

TABLE 4

| | | Negative electrode conductive agent | | | | | | |
|---|---|---|---|---|---|---|---|---|
| | | | | | Amount | Theoretical | | |
| | Si | | | | added | capacity | | |
| | powder | | | BET | (with | ratio of | | |
| | average | | Average | specific | respect | positive | | |
| | particle | | particle | surface | to Si | electrode to | | |
| | size | | size | area | powder, | negative | Initial | Cycle |
| Battery | (μm) | Material | (μm) | (m²/g) | mass %) | electrode | performance | life |
| W | 5.5 | Graphite | 9.5 | 6.5 | 15 | [symbol] | 97 | 45 |
| D1 | 5.5 | Graphite | 9.5 | 6.5 | 15 | [symbol] | 103 | 95 |
| D2 | 5.5 | Graphite | 9.5 | 6.5 | 15 | [symbol] | 102 | 98 |
| A1 | 5.5 | Graphite | 9.5 | 6.5 | 15 | [symbol] | 100 | 100 |

Note:
The values of initial performance and cycle performance are expressed in relative values to those of Battery A1, which are taken to be 100.
The values shown in bold italics are the primary variables.

As clearly seen from Table 4, Batteries D1 and D2 of the invention as well as Battery A1 of the invention, in which the theoretical capacity ratios of the positive electrode to the negative electrode were 1.00 or less, were superior in both initial performance and cycle performance to Comparative Battery W, in which the theoretical capacity ratio of the positive electrode to the negative electrode was 1.46.

It is believed that the above results are attributable to the following reasons.

When the theoretical electrical capacity ratio of the positive electrode to the negative electrode exceeds 1.00 as in Comparative Battery W, the utilization factor of the negative electrode will be high, increasing the change in volume of silicon during the lithium intercalation and deintercalation. As a consequence, a large number of cracks in silicon will occur during charging and discharging. In contrast, when the theoretical electrical capacity ratio of the positive electrode to the negative electrode is 1.00 or less as in Batteries D1 and D2 of the invention as well as Battery A1 of the invention, the utilization factor of the negative electrode will be low, and the change in volume of silicon is accordingly small during the lithium intercalation and deintercalation. Thus, cracks in silicon are prevented during charging and discharging.

### Fifth Embodiment

### Comparative Examples V1 to V3

Lithium secondary batteries were fabricated in the same manner as in Example A1 of the first embodiment, except that hard carbon, acetylene black, and Ketjen Black were used in place of graphite as the negative electrode conductive agent, respectively. It should be noted, however, that the average particle sizes and the BET specific surface areas of the negative electrode conductive agents also varied because of the use of hard carbon, acetylene black, and Ketjen Black. Also, in the battery using Ketjen Black, the amount of the added negative electrode conductive agent was also varied.

The batteries thus fabricated are hereinafter referred to as Comparative Batteries V1 to V3, respectively.

Experiment

Comparative Batteries V1 to V3 were charged and discharged under the same charge-discharge conditions set out in the experiment of the first embodiment, and their initial performance and cycle performance were studied in the same manner as described in the experiment of the first embodiment. The results are shown in Table 5 below. Table 5 also shows the experimental results for Battery A1 of the invention.

TABLE 5

| | | Negative electrode conductive agent | | | | | | |
|---|---|---|---|---|---|---|---|---|
| | | | | | Amount | Theoretical | | |
| | Si | | | | added | capacity | | |
| | powder | | | BET | (with | ratio of | | |
| | average | | Average | specific | respect | positive | | |
| | particle | | particle | surface | to Si | electrode to | | |
| | size | | size | area | powder, | negative | Initial | Cycle |
| Battery | (μm) | Material | (μm) | (m²/g) | mass %) | electrode | performance | life |
| A1 | 5.5 | [symbol] | 9.5 | 6.5 | 15 | 0.64 | 100 | 100 |
| V1 | 5.5 | [symbol] | 9 | 6.3 | 15 | 0.64 | 84 | 74 |
| | | [symbol] | | | | | | |
| V2 | 5.5 | [symbol] | 0.035 | 68 | 5 | 0.64 | 102 | 41 |
| | | [symbol] | | | | | | |
| V3 | 5.5 | [symbol] | 0.040 | 800 | 5 | 0.64 | 103 | 32 |
| | | [symbol] | | | | | | |

Note:
The values of initial performance and cycle performance are
expressed in relative values to those of Battery A1, which are taken to be 100.
The values shown in bold italics are the primary variables.

As clearly seen from Table 5, Comparative Battery V1, which used hard carbon as the negative electrode conductive agent, was inferior in both initial performance and cycle performance to Battery A1 of the invention, which used graphite as the negative electrode conductive agent. Comparative Batteries V2 and V3, which used acetylene black and Ketjen Black, respectively, were inferior in cycle performance to Battery A1 of the invention, which used graphite as the negative electrode conductive agent.

It is believed that the above results are attributable to the following reasons.

In the case that hard carbon is used as the negative electrode conductive agent as in Comparative Battery V1, the negative electrode conductive agent cannot exhibit the function as a conductive agent since hard carbon has low crystallinity and low conductivity. Consequently, both initial performance and cycle performance will degrade. In the case that acetylene black and Ketjen Black are used as the negative electrode conductive agent as in Comparative Batteries V2 and V3, the proportion of the negative electrode binder that is present on the surface of the negative electrode conductive agent will be too large since the average particle size will be too small (the BET specific surface area will be too large). As a result, the contact between the negative electrode active material particles cannot be maintained, and the cycle performance is lowered. In contrast, in the case that a graphite material is used as the negative electrode conductive agent as in Battery A1 of the invention, the graphite material shows high performance as a conductive agent since the graphite material has high crystallinity and high conductivity, and moreover, the average particle size is not too small. Therefore, the contact between the negative electrode active material particles is sufficiently ensured, and consequently, high current collection performance is achieved in the negative electrode mixture layer.

The present invention is applicable not only to driving power sources for mobile information terminals such as mobile telephones, notebook computers and PDAs but also to large-sized batteries for, for example, in-vehicle power sources for electric automobiles or hybrid automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application No. 2005-259089, filed Sep. 7, 2005, which is incorporated herein by reference.

What is claimed is:

1. A lithium secondary battery comprising:
a positive electrode;
a non-aqueous electrolyte; and
a negative electrode comprising a negative electrode current collector and a negative electrode mixture layer that contains a negative electrode conductive agent, a negative electrode binder, and negative electrode active material particles made of a material containing silicon, the negative electrode mixture layer being sintered and disposed on the negative electrode current collector, wherein:
the negative electrode active material particles have an average particle size of from 5.0 μm to 15.0 μm before being charged; the negative electrode conductive agent comprises a graphite material having an average particle size of from 2.5 μm to 15.0 μm; the amount of the graphite material added is from 3 mass % to 20 mass % with respect to the negative electrode active material; and a theoretical electrical capacity ratio of the positive electrode to the negative electrode is 1.0 or less.

2. The lithium secondary battery according to claim 1, wherein the graphite material has a BET specific surface area of 15 m²/g or less.

3. The lithium secondary battery according to claim 1, wherein the negative electrode binder comprises polyimide.

4. The lithium secondary battery according to claim 2, wherein the negative electrode binder comprises polyimide.

5. The lithium secondary battery according to claim 3, wherein the polyimide has a glass transition temperature of 350° C. or lower.

6. The lithium secondary battery according to claim 4, wherein the polyimide has a glass transition temperature of 350° C. or lower.

7. The lithium secondary battery according to claim 1, wherein the negative electrode active material consists of silicon.

8. The lithium secondary battery according to claim 2, wherein the negative electrode active material consists of silicon.

9. The lithium secondary battery according to claim 3, wherein the negative electrode active material consists of silicon.

10. The lithium secondary battery according to claim 4, wherein the negative electrode active material consists of silicon.

11. The lithium secondary battery according to claim 5, wherein the negative electrode active material consists of silicon.

12. The lithium secondary battery according to claim 6, wherein the negative electrode active material consists of silicon.
